(19) United States
(12) Patent Application Publication
(10) Pub. No.: US 2016/0066534 A1
(43) Pub. Date: Mar. 10, 2016

(54) Tie Handle Training Pad

(71) Applicants: Robert Perissi, Simsburg, CT (US); Douglas J Russell, Jericho, NY (US); Richard D'Angeli, Framingham, MA (US)

(72) Inventors: Robert Perissi, Simsburg, CT (US); Douglas J Russell, Jericho, NY (US); Richard D'Angeli, Framingham, MA (US)

(73) Assignee: MEDNET DIRECT CORP, Farmington, CT (US)

(21) Appl. No.: 14/850,953

(22) Filed: Sep. 11, 2015

Related U.S. Application Data
(60) Provisional application No. 62/048,714, filed on Sep. 10, 2014.

(51) Int. Cl. A01K 1/015; B32B 5/02; B32B 3/26; B32B 27/12; B32B 27/32; B32B 3/02

(52) U.S. Cl. CPC A01K 1/0157; B32B 27/32; B32B 3/02; B32B 3/266; B32B 27/12; B32B 5/022; B32B 3/263; A01K 1/0155; B32B 2305/20; B32B 2307/7265

(57) ABSTRACT

An enclosable potty-training pad is an apparatus used to potty-train young pets and allows a user to grasp and dispose the apparatus in a sanitary manner. The apparatus includes a plurality of ties and a base pad. The base pad collects and retains liquid and/or solid waste of a young pet. The base pad includes multiple functional layers in order to strain the solid portions of the waste from the liquid portions of the waste, to absorb and retain the liquid portions, and to prevent any excess waste from overflowing off the base pad. The ties are used to fasten the outer edges of the base pad together. Each tie includes handles positioned opposite to each other across the base pad. The handles allow the user to grasp the apparatus without coming into physical contact with the waste and may be tied together to secure the waste within the apparatus.

The current application claims a priority to the U.S. Provisional Patent application Ser. No. 62/048,714 filed on Sep. 10, 2014.

### FIELD OF THE INVENTION

The present invention generally relates to the house training of domesticated animals. More specifically, the present invention relates to a training pad with tie handles located at each corner of the product. The corners provide pet owners with the ability to easily grasp the training pad and have the option of tying the handles together, and, thus, creating a convenient means to contain and dispose of the soiled training pad in a more sanitary manner.

### BACKGROUND OF THE INVENTION

Whenever a person gets a new house pet such as a dog or cat, one of the biggest challenges is house training the pet. This can be a difficult task as almost no new pet can resist the urge to defecate in various locations within a household. With this in mind, an important goal for a new pet owner is to teach the animal to relieve itself in single location that is the least offensive and noticeable as possible. Luckily, animal training pads have been developed to help solve this problem.

Animal training pads are generally rectangular in shape and consist of multiple layers of various moisture absorbent polymers. Usually, the bottom layer is made out of polyethylene that extends to each outer edge of the training pad. Many training pads are scented with pet attractants that attract the pets to it when they need to relieve themselves.

For many pet owners, a daunting task arises when they must dispose of the training pad. This process usually consists of the pet owner reluctantly grabbing the corners or edges of the pad and either crumpling, folding, or attempting to tie the corners together before placing the object into the proper waste disposal unit. Many products exist that try to fix this problem, but they are generally ineffective, complicated, or more expensive. For example, some products are designed to help the user tie up the pad through the use of tear-able edges or a drawstring. While this is certainly a solution, these additional features increase the manufacturing cost, thus the overall price to the consumer. As well as this, the majority of products currently offered on the market are standard shapes and colors that may be unattractive to the user.

It is therefore an objective of the present invention to provide a training pad with extended handles. The handles provide pet owners the ability to easily grasp the pad and have the option of tying them together, thus creating a convenient means to contain and dispose of the soiled training pad in a more sanitary manner. The present invention can be used in places that include, but are not limited to, commercial, industrial, and home settings in order to protect surfaces from defecation, spills, and other liquids.

### BRIEF DESCRIPTION OF THE DRAWINGS

FIG. 1 is a front-side elevational view of the present invention, displaying the absorbent layer, PE film layer, and tie handles extending from the corners of the PE film layer.

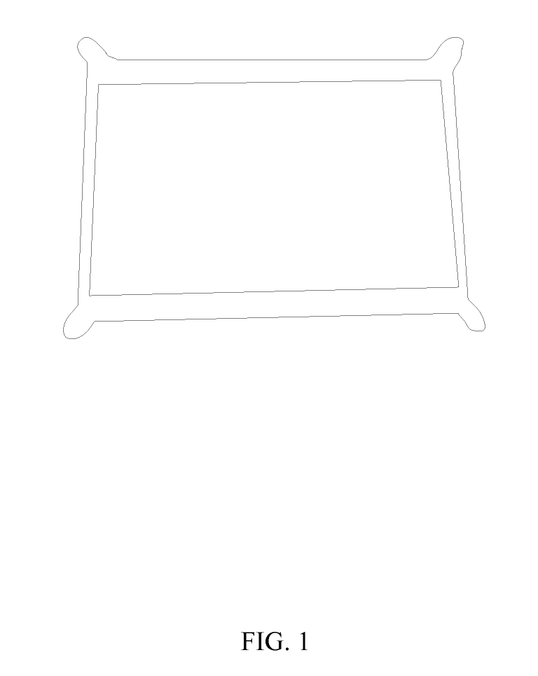

FIG. 2 is a back-side elevational view of the present invention, displaying the side of the PE film layer not shown in FIG. 1.

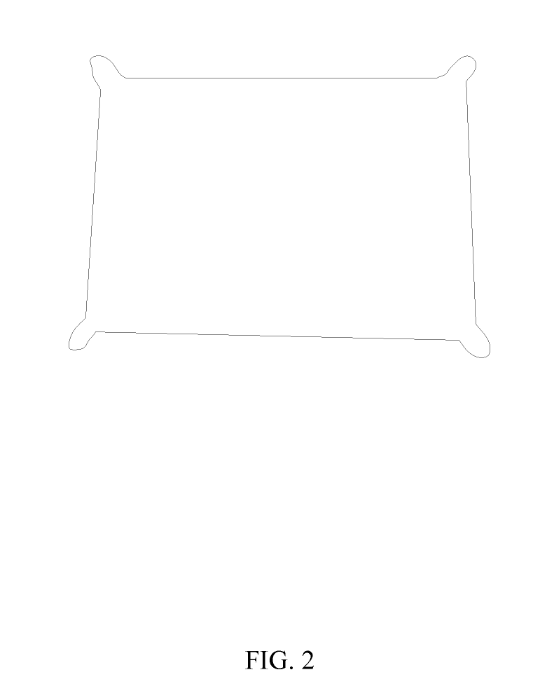

FIG. 3 is perspective view of the present invention as it may lie on the ground before being tied up and disposed of. The absorbent layer is on a different plane than the PE film layer.

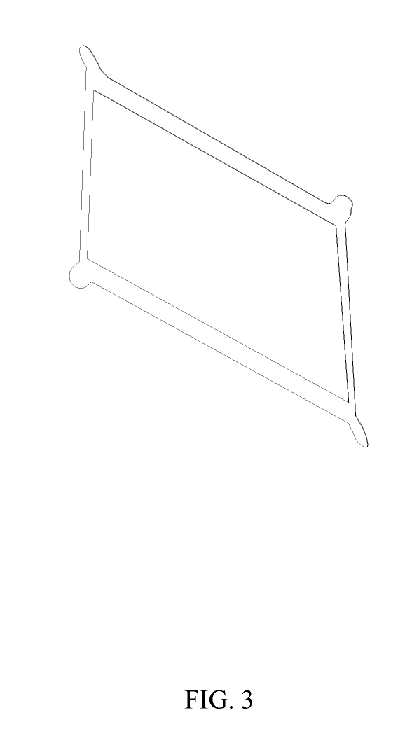

FIG. 4 is a perspective view of the present invention, displaying the tie handles being brought together before pre-disposal.

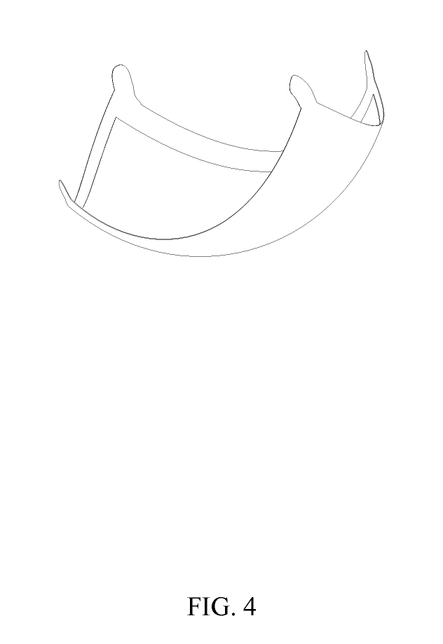

### DETAILED DESCRIPTION OF THE INVENTION

All illustrations of the drawings are for the purpose of describing selected versions of the present invention and are not intended to limit the scope of the present invention.

The present invention is an enclosable potty-training pad, which allows a user to secure and envelope excrements by tying the two opposing extremities of the present invention together. The present invention is designed to potty-train a young animal such as a puppy or a kitten, but the present invention can also be used for adult dogs or cats. The present invention can also be used to collect excrements of other domesticated animals such as birds or reptiles or to collect excrements of humans. The present invention comprises a plurality of ties 1 and a base pad 2. The base pad 2 is used to collect and retain either liquid and/or solid waste from an animal. When the base pad 2 is folded upon itself to further secure the liquid and/or solid waste within the present invention, the plurality of ties 1 can then be used to fasten outer edges of the base pad 2 together, which encloses the liquid and/or solid waste within the present invention.

The configuration of the plurality of ties 1 in relation to the base pad 2 allows the user to easily secure and enclose any kind of waste within the present invention. Consequently, each of the plurality of ties 1 comprises a first handle 11, a second handle 12, and a tying reference line 13. The first handle 11 and the second handle 12 are flaccid protrusions that extend from the base pad 2 and are knotted together in order secure the corresponding outer edges of the base pad 2 together. Typically, the first handle 11 and the second handle 12 are oblong shape and extend outward from the base pad 2. The first handle 11 is perimetrically connected to the base pad 2, and the second handle 12 is perimetrically connect to the base pad 2 so that the user is able to grasp the present invention without coming into physical contact with the waste located on the base pad 2. The tying reference line 13 is a geometric reference line for each of the plurality of ties 1 that is used orient the first handle 11 and the second handle 12 opposite to each other across the base pad 2. The tying reference line 13 is a straight line that traverses from the first handle 11, across the base pad 2, and to the second handle 12. The tying reference line 13 also intersects with a center point 21 of the base pad 2. This configuration between the first handle 11, the second handle 12, and the tying reference line 13 allows the user to grasp the present invention from opposing sides and allows the user to easily tie a knot between the first handle 11 and the second handle 12 in order to enclose the present invention. Finally, the tying reference line 13 of for each of the plurality of ties 1 is radially distributed about the center point 21 of the base pad 2, which allows the user to grasp the present invention at multiple radial points about the base pad 2.

The following description outlines the disposal process of the present invention. If the user decides to use the first handle 11 and the second handle 12, the user would begin by grasping the first handle 11 and the second handle 12, partially closing the base pad 2, and enclosing the waste within the present invention. Next, the user would create a simple knot by tying the first handle 11 and the second handle 12 together. Afterwards, the user may repeat the process with each of the plurality of ties 1 and continue this process until the user has completely enclosed the waste/undesirable material to their choosing. If the user chooses, the user may also tie a knot that comprises the previously knotted or unknotted handles. This process will ensure the base pad 2 stays closed while transporting it to a waste disposal unit, creating a more sanitary environment and limiting the risk of the pad unfolding and exposing/spilling waste.

The base pad 2 is designed with multiple layers so that each layer is able to accomplish a specialized function. Consequently, the base pad 2 comprises a non-absorbent permeable layer 22, an at least one absorbent layer 23, and a non-permeable layer 24. The non-absorbent permeable layer 22 is used to strain the solid portion of the waste out of the liquid portion of the waste. The non-absorbent permeable layer 22 is superimposed across the absorbent layer 23 because the liquid portion of the waste can then immediately be retained after passing through the non-absorbent permeable layer 22. The absorbent layer 23 is superimposed across the non-permeable layer 24 so that any overflow from the liquid portion of the waste is still collected onto the non-permeable layer 24. Typically, the non-permeable layer 24 is the bottom layer of the base pad 2 when the present invention is placed on the ground. In some embodiments of the present invention, the first handle 11 and the second handle 12 for each of the plurality of ties 1 and the non-permeable layer 24 is constructed from one continuous piece of material. In the preferred embodiment of the present invention, the non-absorbent permeable layer 22 is made of a non-woven fabric material, and the non-permeable layer 24 is made of a polyethylene film. Also in the preferred embodiment, the absorbent layer 23 is made of a super absorbent polymer material, but, in some other embodiments, the absorbent layer 23 is made of a pulp material, a tissue material, or combinations thereof. Any of the aforementioned layers of the base pad 2 can be designed with any thickness or with any color. In addition, each layer of the base pad 2 can be attach to the next layer by means that include, but are not limited to, gluing, sewing, and heat sealing. In other embodiments of the present invention, the layers of the base pad 2 may be made out of recyclable materials as long as the scope and objective remain unchanged.

Some additional features can be integrated into the present invention when the base pad 2 is designed with multiple layers. One such feature is a plurality of channels 3 that is embossed into the non-absorbent permeable layer 22, which aids the present invention in distributing the liquid portions of the waste across the entire absorbent layer 23 instead of pooling the liquid portions of the waste into one section of the absorbent layer 23. Another such feature is a spill guard configured by differently sizing each of the layers. Thus, a lateral boundary of the non-absorbent permeable layer 22 is coincident with a lateral boundary of the absorbent layer 23, and a lateral boundary of the non-permeable layer 24 is perimetrically offset from the lateral boundary of the non-absorbent permeable layer 22 and the lateral boundary of the absorbent layer 23. The spill guard is the portion of the non-permeable layer 24 that extends from the coincident relation between the non-absorbent permeable layer 22 and the absorbent layer 23. The spill guard provides the base pad 2 with a larger collection area for liquid and/or solid waste. In some embodiments of the present invention, a rim 4 is perimetrically connected normal about the non-permeable layer 24 so that the rim 4 can act as last barrier in case of excess overflow.

In some scenarios, the present invention is not able to adequately enclose the liquid and/or solid waste with a knot between the first handle 11 and the second handle 12. Thus, each of the plurality of ties 1 further comprises a first tie-locking slit 14 and a second tie-locking slit 15. The first tie-locking slit 14 traverses through the first handle 11, and the second tie-locking slit 15 traverses through the second handle 12. A zip-tie, a string, or some similar cord-type fastener is roped through the first tie-locking slit 14 and the second tie-locking slit 15 and is tied together in order to assist the knot between the first handle 11 and the second handle 12 in adequately enclosing the liquid and/or solid waste within the present invention.

The base pad 2 can configured in multiple shapes, but, in the preferred embodiment of the present invention, the base pad 2 is a rectangular sheet shape, which minimizes manufacturing costs of the present invention. Consequently, the plurality of ties 1 is only a first tie 101 and a second tie 102. More specifically in this embodiment, the first handle 11 and the second handle 12 for the first tie 101 is positioned on a first pair of diagonally opposing corners on the rectangular sheet shape, and the first handle 11 and the second handle 12 for the second tie 102 is positioned on a second pair of diagonally opposing corner on the rectangular sheet. This configuration for the first tie 101 and the second tie 102 is efficient and effective for the user because this configuration allows the user to grasp the present invention from any corner of the base pad 2. In other embodiments of the present invention, the base pad 2 can be configured as a caricature of a bone, cross, dog, car, tree, etc. for aesthetic purposes. In these embodiments of the present invention, the tie handles will extend from the outermost perimeter of the PE film layer shape/design. These variances may occur as long as the scope and objective of the present invention remains unchanged.

The present invention can be used in a variety of ways extending beyond potty-training for young animals. The present invention may also be used for human incontinence as well as for medical/hospital, automotive, janitorial, sanitation, restaurant cooking/cleanup, and artist waste. In these industries, the present invention may be used to collect waste, garbage, liquids, etc. For example, in the automotive industry, the present invention would work well to absorb grease and oil, while it may be useful in restaurant settings to collect, absorb, and dispose of knocked over or spilled ingredients. Overall, the present invention can be used in almost any setting or industry to assist with waste disposal as long as the scope and objective remains unchanged.

Although the invention has been explained in relation to its preferred embodiment, it is to be understood that many other possible modifications and variations can be made without departing from the spirit and scope of the invention as hereinafter claimed.

What is claimed is:

1. An enclosable potty-training pad comprises:
a plurality of ties;
a base pad;
each of said plurality of ties comprises a first handle, a second handle, and a tying reference line;
said first handle being perimetrically connected to said base pad;
said second handle being perimetrically connected to said base pad;
said tying reference line being a straight line;
said tying reference line traversing from said first handle, across said base pad, and to said second handle;
said tying reference line intersecting with a center point of said base pad; and
said tying reference line for each of said plurality of ties being radially distributed about said center point of said base pad.

2. The enclosable potty-training pad as claimed as claim 1 comprises:
said base pad comprises a non-absorbent permeable layer, an at least one absorbent layer, and a non-permeable layer;
said non-absorbent permeable layer being superimposed across said absorbent layer; and
said absorbent layer being superimposed across said non-permeable layer.

3. The enclosable potty-training pad as claimed as claim 2 comprises:
a lateral boundary of said non-absorbent permeable layer being coincident with a lateral boundary of said absorbent layer; and
a lateral boundary of said non-permeable layer being perimetrically offset from said lateral boundary of said non-absorbent permeable layer and said lateral boundary of said absorbent layer.

4. The enclosable potty-training pad as claimed as claim 1 comprises:
a plurality of channels; and
said plurality of channels being embossed into said non-absorbent permeable layer.

5. The enclosable potty-training pad as claimed as claim 2 comprises:
a rim; and
said rim being perimetrically connected normal to the non-permeable layer.

6. The enclosable potty-training pad as claimed as claim 2, wherein said non-absorbent permeable layer is made of a non-woven fabric material.

7. The enclosable potty-training pad as claimed as claim 2, wherein said absorbent layer is made of a super absorbent polymer material.

8. The enclosable potty-training pad as claimed as claim 2, wherein said non-permeable layer is made of a polyethylene film.

9. The enclosable potty-training pad as claimed as claim 1 comprises:
each of said plurality of ties further comprises a first tie-locking slit and a second tie-locking slit;
said first tie-locking slit traversing through said first handle; and
said second tie-locking slit traversing through said second handle.

10. The enclosable potty-training pad as claimed as claim 1 comprises:
said base pad being a rectangular sheet shape;
said plurality of ties being a first tie and a second tie;
said first handle and said second handle for said first tie being positioned on a first pair of diagonally opposing corners on said rectangular sheet shape; and
said first handle and said second handle for said second tie being positioned on a second pair of diagonally opposing corners on said rectangular sheet shape.

11. An enclosable potty-training pad comprises:
a plurality of ties;
a base pad;
each of said plurality of ties comprises a first handle, a second handle, and a tying reference line;
said base pad comprises a non-absorbent permeable layer, an at least one absorbent layer, and a non-permeable layer;
said first handle being perimetrically connected to said base pad;
said second handle being perimetrically connected to said base pad;
said tying reference line being a straight line;
said tying reference line traversing from said first handle, across said base pad, and to said second handle;
said tying reference line intersecting with a center point of said base pad;
said tying reference line for each of said plurality of ties being radially distributed about said center point of said base pad;
said non-absorbent permeable layer being superimposed across said absorbent layer; and
said absorbent layer being superimposed across said non-permeable layer.

12. The enclosable potty-training pad as claimed as claim 11 comprises:
a lateral boundary of said non-absorbent permeable layer being coincident with a lateral boundary of said absorbent layer; and
a lateral boundary of said non-permeable layer being perimetrically offset from said lateral boundary of said non-absorbent permeable layer and said lateral boundary of said absorbent layer.

13. The enclosable potty-training pad as claimed as claim 11 comprises:
a plurality of channels;
a rim;
said plurality of channels being embossed into said non-absorbent permeable layer; and
said rim being perimetrically connected normal to the non-permeable layer.

14. The enclosable potty-training pad as claimed as claim 11 comprises:
said non-absorbent permeable layer being made of a non-woven fabric material;
said absorbent layer being made of a super absorbent polymer material; and
said non-permeable layer being made of a polyethylene film.

15. The enclosable potty-training pad as claimed as claim 11 comprises:
each of said plurality of ties further comprises a first tie-locking slit and a second tie-locking slit;
said first tie-locking slit traversing through said first handle; and
said second tie-locking slit traversing through said second handle.

16. The enclosable potty-training pad as claimed as claim 11 comprises:
said base pad being a rectangular sheet shape;
said plurality of ties being a first tie and a second tie;
said first handle and said second handle for said first tie being positioned on a first pair of diagonally opposing corners on said rectangular sheet shape; and
said first handle and said second handle for said second tie being positioned on a second pair of diagonally opposing corners on said rectangular sheet shape.

17. An enclosable potty-training pad comprises:
a plurality of ties;
a base pad;
each of said plurality of ties comprises a first handle, a second handle, and a tying reference line;
said base pad comprises a non-absorbent permeable layer, an at least one absorbent layer, and a non-permeable layer;
said first handle being perimetrically connected to said base pad;
said second handle being perimetrically connected to said base pad;
said tying reference line being a straight line;
said tying reference line traversing from said first handle, across said base pad, and to said second handle;
said tying reference line intersecting with a center point of said base pad;
said tying reference line for each of said plurality of ties being radially distributed about said center point of said base pad;
said non-absorbent permeable layer being superimposed across said absorbent layer;
said absorbent layer being superimposed across said non-permeable layer;
a lateral boundary of said non-absorbent permeable layer being coincident with a lateral boundary of said absorbent layer; and
a lateral boundary of said non-permeable layer being perimetrically offset from said lateral boundary of said non-absorbent permeable layer and said lateral boundary of said absorbent layer.

18. The enclosable potty-training pad as claimed as claim 17 comprises:
a plurality of channels;
a rim;
each of said plurality of ties further comprises a first tie-locking slit and a second tie-locking slit;
said plurality of channels being embossed into said non-absorbent permeable layer;
said rim being perimetrically connected normal to the non-permeable layer;
said first tie-locking slit traversing through said first handle; and
said second tie-locking slit traversing through said second handle.

19. The enclosable potty-training pad as claimed as claim 17 comprises:
said non-absorbent permeable layer being made of a non-woven fabric material;
said absorbent layer being made of a super absorbent polymer material; and
said non-permeable layer being made of a polyethylene film.

20. The enclosable potty-training pad as claimed as claim 17 comprises:
said base pad being a rectangular sheet shape;
said plurality of ties being a first tie and a second tie;
said first handle and said second handle for said first tie being positioned on a first pair of diagonally opposing corners on said rectangular sheet shape; and
said first handle and said second handle for said second tie being positioned on a second pair of diagonally opposing corners on said rectangular sheet shape.
